(19) United States
(12) Patent Application Publication
(10) Pub. No.: US 2022/0090717 A1
(43) Pub. Date: Mar. 24, 2022

(54) QUICK CONNECT DEVICE FOR RECREATIONAL AND INDUSTRIAL USES

(71) Applicant: James Phil Starck, San Diego, CA (US)

(72) Inventor: James Phil Starck, San Diego, CA (US)

(21) Appl. No.: 17/151,629

(22) Filed: Jan. 18, 2021

Related U.S. Application Data
(60) Provisional application No. 62/962,899, filed on Jan. 17, 2020.

(51) Int. Cl. F16L 37/091

(52) U.S. Cl. CPC F16L 37/091

(57) ABSTRACT

A connection system comprised of a quick connect and receptacle wherein the quick connect has a coupling side that complements the receptacle and a functional side adapted for industrial, recreational, and consumer uses. The quick connect and receptacle are adapted for low pressure compression upon initial insertion, low friction twist of 180 degrees or less to reach a locking position.

### FIELD OF THE INVENTION

The present invention relates in general to quick connect devices. It more particularly relates to a male quick connect and a female receptacle that form a quick connect device that allows for quick attachment and detachment of various devices for recreational and industrial uses.

### RELATED APPLICATIONS

This application claims priority to U.S. provisional application No. 62/962,899 filed Jan. 17, 2020 and is incorporated in its entirety herein.

### BACKGROUND ART

There is no admission that the background art disclosed in this section legally constitutes prior art.

VELCRO® aka hook and loop is a well known product for connecting two items to each other. Similarly the present invention uses a novel design and method for attaching two items. In particular, the present invention connects surfboard leashes to surfboards. There are many industrial, recreational, and consumer applications for the present invention to quickly attach and detach two or more items. Many applications for removable attachment exist like VELCRO® while other well-known products from 3M® removable adhesive strips sold under the COMMAND® trademark. Thus, there have been many different types and kinds of quick connect products that can be single use or multiple use designs.

The surfing leashes available on the market today consist of a urethane cord with a Velcro® ankle or calf strap attached on one end and a Velcro® strap with a nylon cord on the other end. Both Velcro® straps are attached to the urethane cord via a metal swivel. The nylon cord is connected to the surfboard by attaching it to a leash plug that is epoxied into the surfboard. The nylon cord is attached to the leash plug by looping it around a metal bar in the leash plug.

For example, reference may be made to U.S. Pat. Nos. 4,938,725; 5,490,805; 5,902,164; and 5,938,492; Australian patent 704985; and International patent application publications WO 92/00873; WO 99/51489; and WO 2006/045166.
The main problem with existing surfing leashes is they are difficult to attach to a surfboard. In order to attach the nylon cord to the metal bar in the surfboard plug, the nylon cord must first be disconnected from the VELCRO® strap and then looped around the metal bar and then reconnected to the VELCRO® strap. This attachment process is time consuming and inconvenient to perform while the surfboard is on land and difficult to perform while the surfboard is in the water. Another problem with the existing surfing leashes is the VELCRO® strap is bulky and heavy and causes excess drag in the water, which is highly undesirable in surfing because it slows down the surfboard. The VELCRO® strap is wrapped around the nylon cord twice to ensure it will not separate during use, which results in a bulky and heavy VELCRO® strap. The VELCRO® strap provides two functions: 1) to connect the nylon cord to the leash plug and 2) to provide protection against damaging the tail and/or side rails of the surfboard in what is called a “rail saver.” This invention is necessary for the following reasons:
It provides a simple push and turn connect and disconnect function that simplifies the leash connection and disconnection processes, in and out of the water.
It eliminates the need for the bulky and heavy VELCRO® strap, reducing drag in the water.
It provides a lighter and thinner rail saver strap, which reduces the overall weight.
This invention solves the problem of leash attachment to a surfboard or watercraft in two ways:
One embodiment of this invention consists of a quick connect and a mating receptacle. The quick connect is designed for attachment to existing surfing leashes. Once the quick connect is attached to a surfing leash, the leash has quick connect/disconnect functionality, enabling it to be easily locked into the mating receptacle, which is bonded or epoxied into the surfboard.
Another embodiment of this invention consists of a custom surfing leash with a built-in quick connect adapter and a mating receptacle. The quick connect can be easily locked into the mating receptacle, which is bonded or epoxied into a surfboard.
   This invention solves the problem of a bulky and heavy Velcro® strap by replacing it with a simple flat strap that is lighter and more flexible and it also provides superior rail saver function because it is much less rigid than a standard Velcro® strap.

### BRIEF DESCRIPTION OF THE DRAWINGS

The features of this invention and the manner of attaining them will become apparent, and the invention itself will be best understood by reference to the following description of certain embodiments of the invention taken in conjunction with the accompanying drawings, wherein:

FIG. 1 is a line drawing of a preferred embodiment wherein a quick connect is engaged with a receptacle in a connected manner.

FIG. 2 shows a quick connect in oblique view.

FIG. 3 shows a receptacle in an oblique view.

FIG. 4 shows a preferred embodiment of a quick connect with finger nuts for grip from a top view.

FIG. 5 shows a preferred embodiment of a quick connect with finger nuts for grip in an oblique view.

FIG. 6 shows a preferred embodiment of a receptacle showing tabs from a side view.

FIG. 7 shows a preferred embodiment of a receptacle showing a through hole from a different side view.

FIG. 8 shows a preferred embodiment of a receptacle from an oblique view showing the rail system with a medial portion and a tab entry portion.

FIG. 9 shows a preferred embodiment of a receptacle from a section view; including, the rail system elements.

FIG. 10 shows a preferred embodiment of a receptacle showing where the A-A section line is derived for FIG. 9.

FIG. 11 shows a preferred embodiment of a receptacle showing where the B-B section line is derived for FIG. 12.

FIG. 12 shows a preferred embodiment of a receptacle showing a section view the distal portion of the rail system.

FIG. 13 shows a preferred embodiment of an accessory attachment portion attached to an adapter from a straight perspective.

FIG. 14 shows a preferred embodiment of an accessory attachment portion attached to the adapter from an oblique angle.

FIG. 15 shows a preferred embodiment of a hook accessory from a front perspective not attached to the adapter.

FIG. 15A shows a cross-section A-A of the hook accessory illustrating structural element of the accessory.

FIG. 15B shows a cross-section B-B of the hook accessory illustrating structural element of the attachment portion.

FIG. 16 shows a preferred embodiment of a hook accessory from an oblique perspective not attached to the adapter.

FIG. 17 shows a preferred embodiment of a hook accessory with attachment portion from an oblique perspective not attached to the adapter.

FIG. 18 shows a preferred embodiment of a hook accessory with attachment portion from a front perspective not attached to the adapter.

FIG. 19 shows a preferred embodiment of a hook accessory attached to the adapter.

FIG. 20 shows a preferred embodiment of a hook accessory attachment portion close up without the adapter.

### DETAILED DESCRIPTION OF CERTAIN EMBODIMENTS OF THE INVENTION

It will be readily understood that the components of the embodiments as generally described and illustrated in the drawings herein, could be arranged and designed in a wide variety of different configurations. Thus, the following more detailed description of certain ones of the embodiments of the system, components and method of the present invention, as represented in the drawings, is not intended to limit the scope of the invention, as claimed, but is merely representative of the embodiments of the invention.

This invention can be used to attach a rider to various types of watercraft, such as:
Surfboard
Standup paddleboard
Kiteboard
Wind surfboard
Safety feature—Allowing the user to disconnect him or herself from the board in cases where the leash becomes hung up or fixed on rocks, reef, or other hazards under the water.
Hydrofoil or Keel surfboard
Kayak
Snowboard
Surfing skis

Additional recreational applications where this type of quick connect system may be implemented include the following: fishing, hunting, camping, boating, hiking, mountaineering, sporting goods, clothing, shoe wear (e.g., to replace laces), etc. Industrial applications where this type of quick connect system may implemented include: electrical connections, mechanical connections and fixation devices, lighting connections, home improvement, plumbing (e.g., hose bibs), medical device connections, gas valve connections trucking and hauling (e.g., tie down connections), cell phone and tablet positioning, etc.

According to one embodiment of the present invention, the quick connect and receptacle can be manufactured out of polymers or metals adapted for their particular purpose. In one embodiment of the invention,

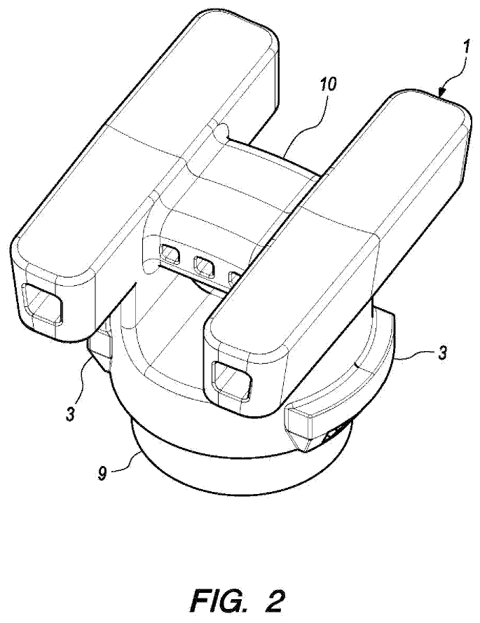

Here are some additional comments:
The gasket can be placed on the receptacle instead of the quick connect.
The gasket provides the locking spring force that pushes the quick connect tabs up into the receptacle grooves, locking the quick connect tabs in place behind the detents in the receptacle.
The gasket can be made from a springy rubber or foam material such as polyurethane or neoprene.
The locking spring force could be provided by a compression spring instead of a springy gasket. The compression spring could made from a metal material, such as stainless steel, or it could be made from a plastic material, such as acetal.
The rotation of the quick connect can be 90° or less for easy hand movement; however multiple complete 360° turns may be required for applications where multiple tabs are placed on a quick connect that can engage a screw-like thread or female cam form in the receptacle for increased engagement and strength.
The locking tabs on the quick connect act like a key to align the quick connect with the receptacle during insertion to ensure the parts are connected and locked together properly.
After insertion and rotation, the tabs act as retention features to lock the quick connect to the receptacle by engaging the mating grooves in the receptacle.
The locking tabs can be formed by various means, such as machining, molding, casting, 3D printing, carving, water jet and laser cutting, etching, etc., depending on the material from which they are fabricated.
The locking tabs can also be created by attaching tabs to the quick connect using attachment methods such as adhesives, press-fits, soldering, brazing, welding or insert molding.
Other methods for forming the tabs can be achieved using build-up or additive techniques such as lamination, potting or sintering.
The locking tabs can be formed with various shapes such as round or cylindrical, square, rectangular, hexagonal, or other unique formed shapes to suit the application or aesthetic requirements.
An example of a cylindrical shape could be created by pressing a dowel pin into a mating hole in the quick connect. Multiple dowel pins could be attached in this manner.
The locking tabs should be sized in accordance with the strength and load requirements of the application; however the shape could be increased for aesthetic reasons or reduced for applications where failure or fracture is desired, such as for a permanent locking application where the quick connect cannot be separated from the receptacle after insertion and locking. In the latter case the fractured tabs would act as locking elements that would block rotation of the quick connect.
The locking tabs 3 in FIG. 2 are sized appropriately for the application and are approximately 2 mm high×10 mm wide×1 mm deep, and are wrapped radially around the quick connect. It is understood by one skilled in the art that these proportions could be adjusted for different applications that require additional force or strength to retain the quick connect and associated functional elements.
The materials used to make the quick connect and receptacle can be natural and/or manmade materials, such as: metals (e.g., stainless steel, brass), plastics (e.g., nylon, polycarbonate), 3D printed materials (e.g., ABS, PLA), elastomeric materials (e.g., rubber, polyurethane) epoxies, wood, stone, ceramics, glass, gemstones, biodegradable materials, etc.

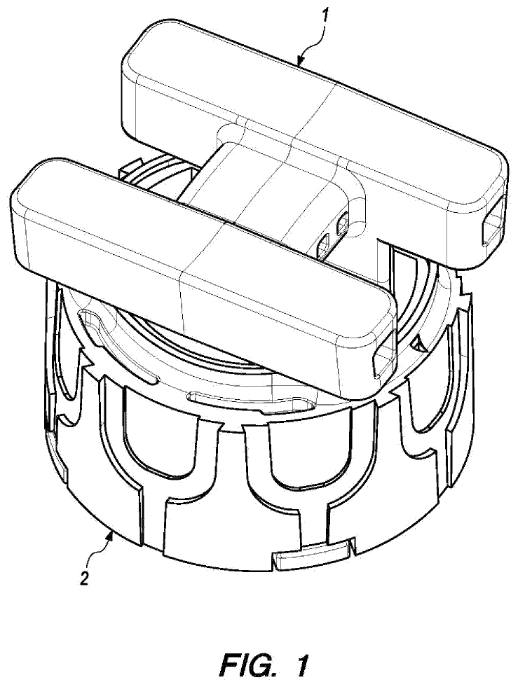

Referring now to FIGS. 1 through 11 of the drawings, there is shown a quick connect 1 and receptacle 2 system joined together in accordance with an embodiment of the present invention and is generally indicated in FIG. 1. As shown in FIG. 1, the quick connect 1 and receptacle 2 are joined together in a fixed state.

FIG. 2 shows a quick connect 1 with individual portions comprising different structural elements. Specifically, tabs 3 are located on the circumference of the generally circular quick connect body. The tabs 3 protrude from the annular body shape of the quick connect 1 and will act as friction fit locks when engaged with the receptacle 2. The quick connect 1 also includes a gasket 9 which has spring like or shape memory like properties so that the material that comprises gasket 9 can be compressed while under pressure and the gasket 9 returns to its pre-compression position when the pressure is removed. Gasket 9 is generally circular in shape and smaller in diameter and circumference than the quick connect body. Quick connect 1 further comprises an adapter 10 that can be configured for different industrial applications. In the present embodiment there is a through hole which a user can place a line through and tie a knot for many different applications such as a surf leash attachment. Many various shapes are possible for the quick connect 1, generally circular in the preferred embodiment though additional polygon shapes with a multiplicity of sides or facets could be employed.

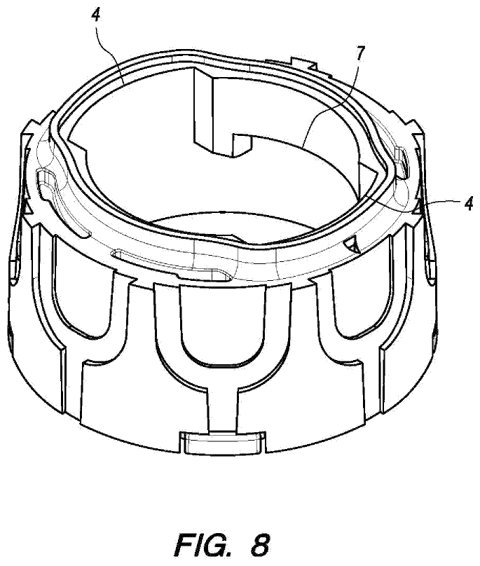

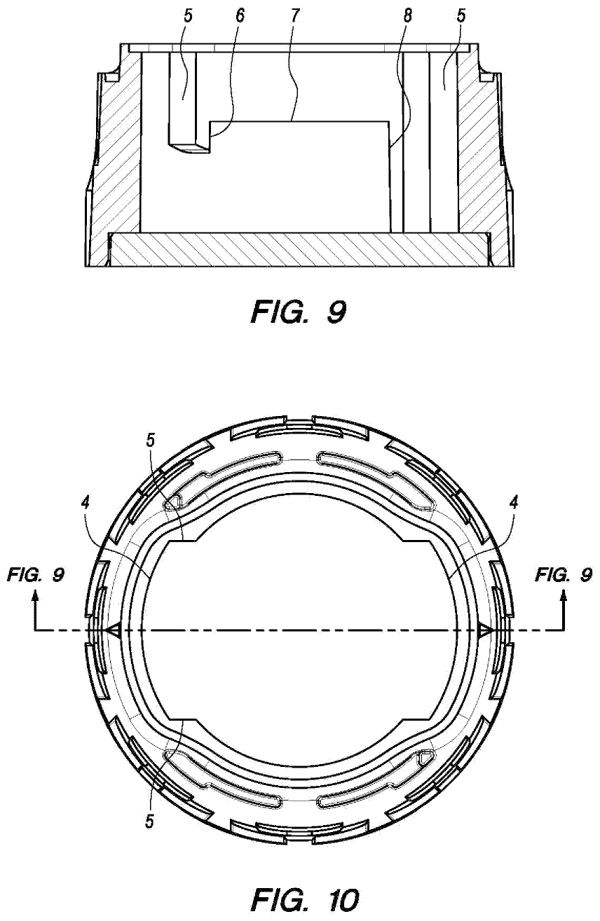

FIG. 3 shows receptacle 2 with a complementary structure to receive the quick connect 1. Receptacle 2 comprises a generally circular body with structural elements making up a locking mechanism with a type of rail system. The rail system/flange is integral to the receptacle body. The rail system/flange comprises a flange opening 4. The flange opening 4 is designed to accept a tab 3 with dimensions of the flange opening 4 just slightly wider circumferentially that then tab 3. The rail system/flange further comprises a proximal portion 5 with an extended protrusion 6 connected to a generally smooth and uniform thickness medial portion 7 and distal portion 8 (shown in FIGS. 9 and 12). The tabs 3 on quick connect 1 are inserted into receptacle 2 and twisted ninety (90) degrees to lock in place. The tabs 3 when inserted into the receptacle 2 pass and possibly contact proximal portion 5 and extended protrusion 6 in an axial direction. Once the tabs 3 clear (are inserted into receptacle 2 far enough) extended protrusion 6 a user can rotate the quick connect 1 to the right circumferentially. This circumferential rotation of the tabs 3 will force the tabs 3 to slide along medial portion 7 until the tabs 3 contact and stop circumferential rotation abutting against distal portion 8 of the receptacle 2. It should be noted that in order for a user to rotate the quick connect 1 inside the receptacle 2 that the gasket 9 must be compressed otherwise the tabs 3 will be blocked from circumferential rotation by contacting the extended protrusion 6 on the receptacle 2. Likewise, when a user attempts to untwist the tabs 3 in the opposite direction, the extended protrusion 6 will block the quick connects 1 release unless a user compresses the gasket 9. Upon insertion, the user releases pressure between the quick connect 1 and receptacle 2 the gasket 9 will expand to its original shape and the tabs 3 will be in contact with both the medial portion 7 and distal portion 8 of the receptacle 2. When the tabs 3 are positioned adjacent the medial portion 7 and the distal portion 8 the quick connect 1 and receptacle 2 are fixedly attached to each other. A user can reverse the motion of the tabs 3 on the quick connect 1 to separate the quick connect 1 from the receptacle 2.

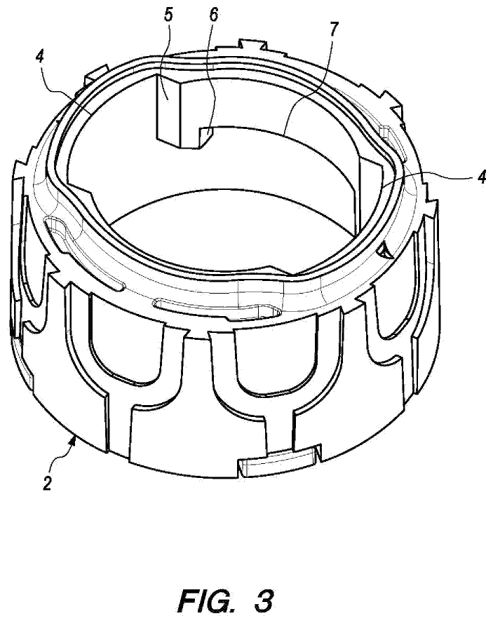

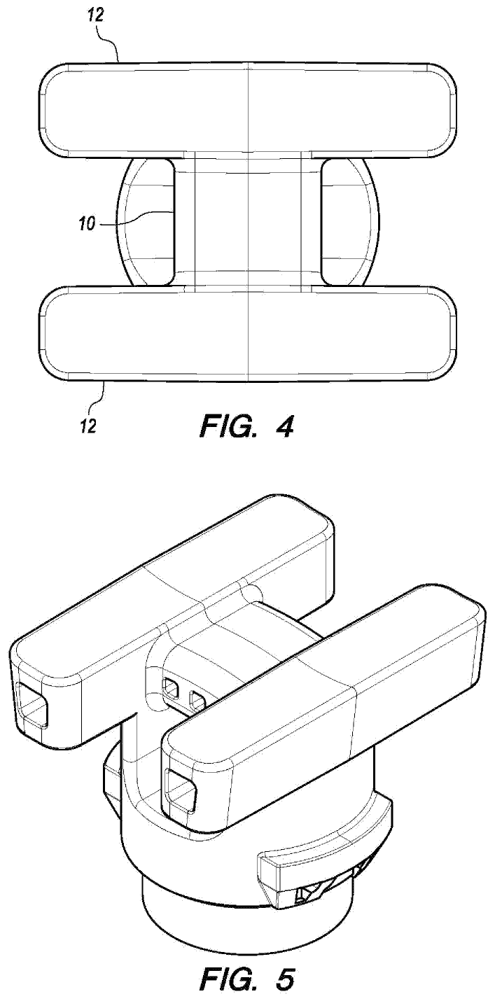

FIGS. 4-5 shows adapter 10 from a top perspective and an oblique perspective. FIG. 4 specifically shows the adapter 10 adapted for use with two finger nuts 12 forming a general H-shape. The finger nuts 12 serve as holds for a user's fingers to hold the quick connect 1. The finger nuts 12 can be in many shapes with the purpose of creating feature that the user can hold easily and use to twist the quick connect 1 into the receptacle 2 circumferentially as well as apply axial pressure for insertion and release of the quick connect 1 from the receptacle 2.

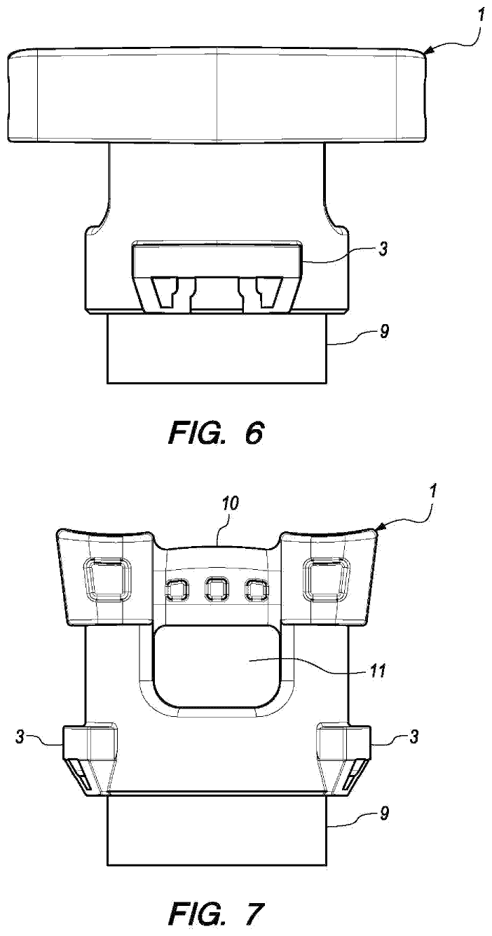

FIG. 6 shows the quick connect 1 with tabs 3 and gasket 9 wherein the thickness of the tabs 3 and gasket 9 are similar. The gasket 9 can be fixed to the quick connect 1 by glue or other adhesive means such as welding depending upon the type of materials used. FIG. 7 shows a cross-sectional view of the quick connect 1 wherein the adapter 10 has a through hole 11 where a user can insert a line and tie a knot. The through hole 11 is optional and can be sized differently for different applications.

FIG. 8 shows flange opening 4 and rail system medial portion 7. Generally, the flange opening 4 will be symmetrical when an even number of tabs 3 are used on the quick connect 1. Generally, the number of tabs 3 and flange openings 4 will be identical and evenly spaced around the circumference of their respective quick connect 1 and receptacle 2 body.

FIGS. 8-10 shows a cross-section of receptacle 2 shows a preferred embodiment where there are two flange openings 4. FIG. 9 specifically shows proximal portion 5, extended protrusion 6, medial portion 7 and distal portion 8. On the cross sectional view it is apparent that proximal portion 5 is fully integrated into the body of the receptacle 2 on proximal portion 5 outside circumference. The proximal portion 5 is seen as having a lip that is the extended protrusion 6. This design allows the tabs 3 to duck under the extended protrusion 6 when the gasket 9 is compressed. FIG. 10 shows a top side perspective of receptacle 2 with a cross-section line A-A. The flange openings 4 are adjacent to the proximal portion 5 and serve as the initial guide path for insertion of the quick connect 1 tabs 3 into the receptacle 2.

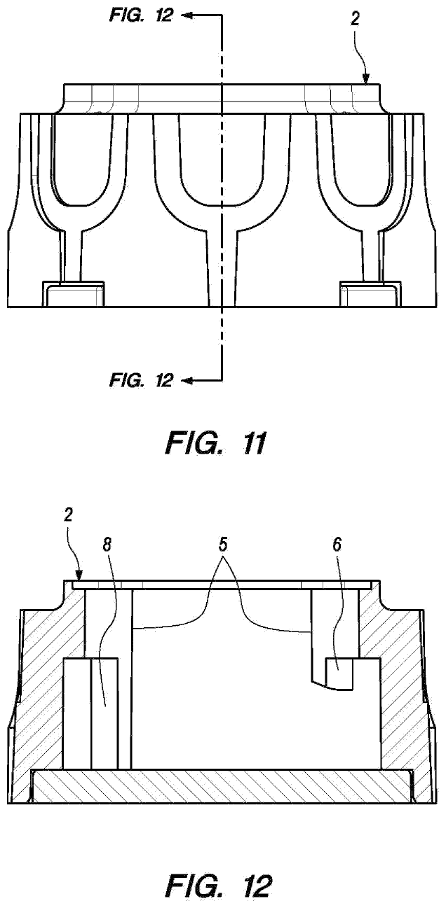

FIGS. 11-12 show a quick connect from a side perspective with a cross-section line designated B-B for FIG. 12. The proximal portion 5 is seen as having a lip that is the extended protrusion 6. This design allows the tabs 3 (not shown) to duck under the extended protrusion 6 when the gasket 9 is compressed. The receptacle 2 can be embedded into almost any type of material so long as it can be fixed, for example a receptacle could be glued into a surfboard.

The quick connect system can be designed for either clockwise or counter clockwise rotation to engage the tabs in the rail system.

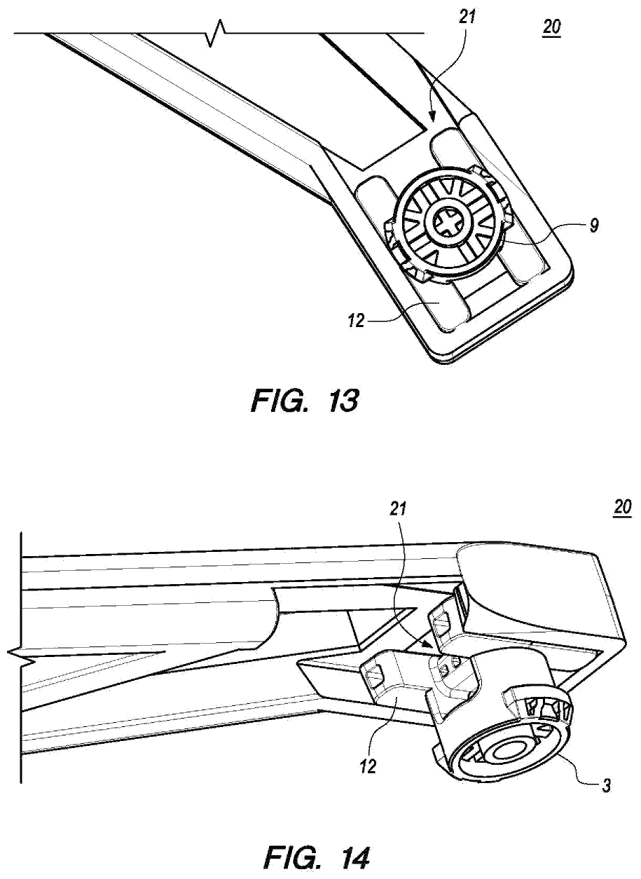

FIGS. 13 and 14 disclose an accessory 20 that can attach to the quick connect system. In the present invention, the finger nuts 12 form an anchor for accessories 20 to be attached. Specifically, a hook accessory has an attachment portion 21 adapted to receive the finger nuts 12 of the adapter 10. The accessory attachment portion 21 mates with the finger nut 12 portion via frictional fit in this preferred embodiment. In this particular application the accessory attachment portion 21 slides over the finger nut 12 portion of the adapter 10. The accessory attachment portion 21 has tab portions that aid in frictional fit to hold the accessory attachment portion 21 in fixed position. The gasket 9 of the adapter 10 obscures view of the adapter 10 in FIG. 13. FIG. 14 shows the accessory attachment portion 21 at an oblique angle with finger nuts 12 engaged. Tabs 3 are shown for orientation and additional perspective. The accessory 20 additionally comprises a functional portion adapted for some purpose such as a hook, so that a surfboard could be connected quickly to a hook for hanging and storage purposes.

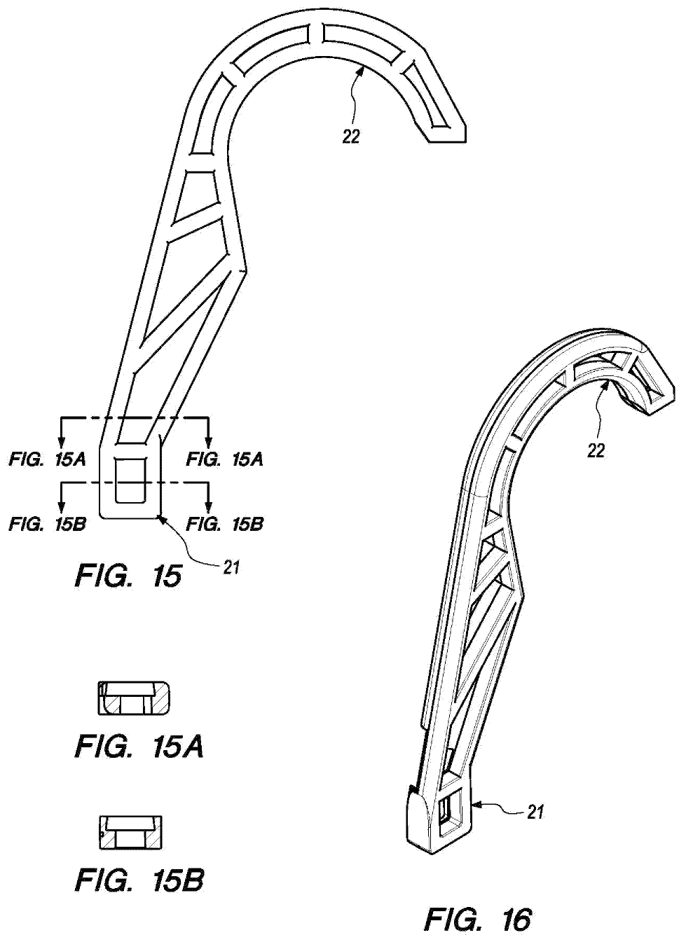

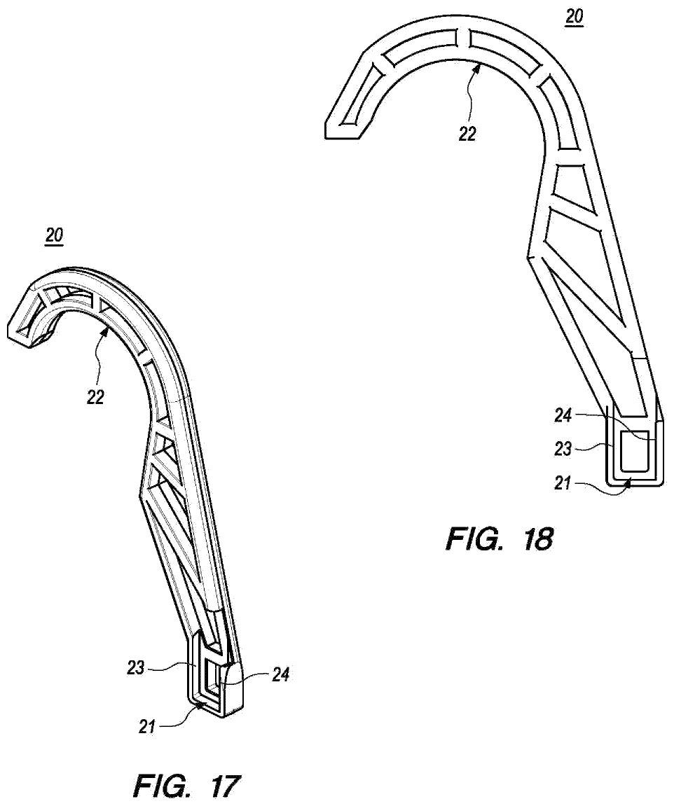

FIGS. 15-18 show engineering drawings of accessory 20. FIG. 15 illustrates an outside side portion of an accessory 20 with an attachment portion 21 integrated into a functional portion 22 wherein the functional portion is a hook. FIG. 16 illustrates an oblique view of the outside side portion of an accessory 20 with an attachment portion 21 integrated into a functional portion 22 wherein the functional portion is a hook.

17 illustrates an inside side portion of an accessory 20 with an attachment portion 21 integrated into a functional portion 22 wherein the functional portion is a hook. The attachment portion 21 further comprises long clip 23 and short clip 24. The long clip 23 and short clip 24 are designed to frictionally fit with the finger nuts 12 of the quick connect 1. FIG. 18 illustrates an oblique view of the inside side portion of the accessory 20 with an attachment portion 21 integrated into a functional portion 22 wherein the functional portion is a hook. Again, the attachment portion 21 further comprises long clip 23 and short clip 24 adapted to grip or frictionally fit the quick connect 1. Additional designs for attachment portion 21 include mating shapes for screw attachment to the quick connect 1. Generally the mating shape for attachment would be adapted on the quick connect 1 positionally where the finger nut 12 could be tapered wider or narrower to fictionally fit the attachment portion 21 by engaging the long clip 23 and short clip 24. It is possible to add detents or protrusions to the clips 23, 24 and have mating detents or protrusions to add additional contact points between the attachment portion 21 and quick connect 1 or finger nut 12 position. For example, the clips 23,24 could be adapted to have teeth or edges shaped to increase engagement contact with a complementary surface on the finger nuts 12.

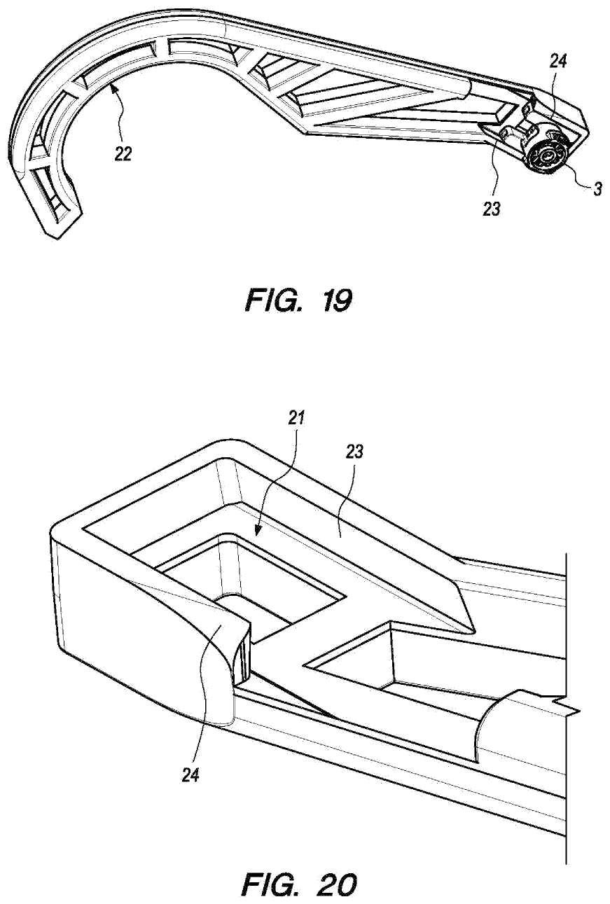

FIG. 19 shows the entire accessory 20 with integrated functional portion 22 and attachment portion 21 long clip 23 and short clip 24 engaged with finger nuts 12 of quick connect 1. FIG. 20 illustrates a close up view of the attachment portion 21 with long clip 23 and short clip 24 with no quick connect 1 engaged.

It should be understood that when words such as “about,” “approximately,” “substantially” or the like are used herein, a tolerance of plus or minus 20 percent may be employed. Further, it is understood that the materials and sizing will be adjusted for the strength and durability of materials for the intended application.

While particular embodiments of the present invention have been disclosed, it is to be understood that various different modifications are passing and one contemplated within the true spirit and scope of the appended claims. There is no intention, therefore, of limitations to the exact abstract or disclosure herein presented.

What is claimed is:

1. A system for connecting two items where in a quick connect with at least one tab is adapted for insertion into a receptacle wherein the receptacle has a rail system comprising a flange opening and a rail with a proximal portion, medial portion and distal portion and wherein the proximal portion has an extended protrusion and wherein the quick connect tabs are inserted past the extended protrusion by compressing a gasket on the quick connect and the quick connect is free to rotate circumferentially relative to the receptacle until the tabs contact a distal portion of the rail system.

2. The system of claim 1 wherein, the quick connect further has finger nuts adapted to engage an accessory.

3. The system of claim 2 wherein the accessory comprises a functional portion and an attachment portion wherein the attachment portion is adapted to engage with the finger nuts.

4. The system of claim 3 wherein the attachment portion comprises a long clip and a short clip to frictionally engage the finger nuts on the quick connect.
